(19) United States
(12) Patent Application Publication
(10) Pub. No.: US 2025/0282645 A1
(43) Pub. Date: Sep. 11, 2025

(54) System and Method for Reducing Target Material in a Liquid Flow

(71) Applicant: SOX, LLC, Boca Raton, FL (US)

(72) Inventors: Ryan LEEDS, Boca Raton, FL (US); Kyle BRISCOE, Southaven, MS (US)

(73) Assignee: SePRO Corporation, Carmel, IN (US)

(21) Appl. No.: 19/072,269

(22) Filed: Mar. 6, 2025

Related U.S. Application Data
(60) Provisional application No. 63/562,247, filed on Mar. 6, 2024.

(51) Int. Cl. C02F 1/00; C02F 101/20; C02F 103/00

(52) U.S. Cl. CPC C02F 1/004; C02F 2101/20; C02F 2103/001; C02F 2201/002; C02F 2307/00

(57) ABSTRACT

A system and method for removing a target substance in a surface or subsurface water flow includes an enclosure formed by a geotextile wrapping material, and a filling composition contained in the enclosure. The filling composition includes an amount of active material dispersed in a media material, where the active material is capable of binding, absorbing or otherwise reacting to the target substance to thereby reducing the amount of the target substance from the resulting water flow exiting the system.

### BACKGROUND

Nitrogen is a major component for biologically important molecules in cells such as proteins, nucleic acids, chlorophyll as well as various bacteria such as nitrifying bacteria and ammoniating bacteria. It is a major plant nutrient and indispensable for plant growth, photosynthesis, and food supply. Although some forms of nitrogen usable by plants can come from biological fixation, natural fixing of nitrogen is insufficient to meet the increasing food and energy demand of the growing population. Thus, fertilizers containing nitrogen are widely used for growing crops and other vegetation.

Phosphorus is a constituent of plant cells, and is involved in several key plant functions such as energy transfer, photosynthesis, cell division and development of the plant Thus, it is another major plant nutrient in the soil.

However, excess nitrogen and phosphorous can harm aquatic ecosystems such as lakes and rivers, causing eutrophication of amphibian systems and the depletion of dissolved oxygen, which could lead to the death of aquatic species and marine organisms. Hyper-nitrification often promotes invasives, harmful algal blooms (HAB), as well as phasing in pH levels that can disrupt the entirety of the aquatic system. This cause and effect will often lead to catastrophic systemic disfunction from plant species and general water quality to diminished fish and invertebrate populations.

To remove excessive nitrogen and phosphors nutrients from aquatic systems, biological nitrification and de-nitrification and chemical precipitation are the most common processes used today to remove nitrogen and phosphorus. However, such approaches usually focus on treating aquatic systems that have already received excessive nitrogen and phosphors nutrients, e.g, in the sediment or water of such aquatic systems.

Some of the nitrogen and phosphorous compounds get into the rivers and lakes and other water bodies not only through on-ground streams, waste-water or effluent industrial discharge, but from run-off from irrigation and rain water carrying such compounds seeping through the soil near the shore of the water bodies. Some aquatic systems receive the majority of the nitrogen and phosphorous compounds in this way. Similarly, other contaminants or harmful chemicals, such as heavy metals, pesticides, hydrocarbons, can also get into aquatic systems this way.

There is a need to develop new and efficient treatment systems for reducing the total nitrogen and phosphorous compounds as well as other contaminants or unwanted chemicals or substances from surface and subsurface water flow before they find their way to aquatic systems.

### SUMMARY OF THE INVENTION

In one aspect, a system for removing a target substance in a surface or subsurface water flow is provided, which includes an enclosure formed by a geotextile wrapping material, and a filling composition contained in the enclosure. The filling composition includes an amount of active material dispersed in a media material, where the active material is capable of binding, absorbing or otherwise reacting to the target substance, thereby reducing the amount of the target substance from the resulting water flow exiting the system.

The enclosure can be installed on or in the ground (including partially in the ground). The geotextile wrapping material when installed on or in the ground can take an open sheet configuration which include a first edge and a second edge opposing the first edge, where the first edge and the second edge are spaced apart by the filling composition. One or both of the first edge and the second edge of the geotextile wrapping material can be secured by at least one stake anchored in the ground. In some embodiments, the geotextile wrapping material can be in the form of a closable bag.

In some embodiments, the geotextile wrapping material comprises a knitted or woven fabric having pores permeable to water. In some embodiments, the fabric material is made from high-density polyethylene or polypropylene.

In some embodiments, the geotextile wrapping material includes a first channel formed at the first edge, and a second channel formed at the second edge. A first draw cord is threaded through the first channel, and a second draw cord is threaded through the second channel. The first and/or the second draw cord can be secured in place by a plurality of stakes anchored in the ground.

In some embodiments, the active material is in the form of a particulate matter, and the average pore size of the geotextile wrapping is smaller than the average size of the active material particulates.

In some embodiments, the target material comprises an organic or inorganic compound containing phosphorous or nitrogen.

In some embodiments, the target substance comprises heavy metals. In some embodiments, the target substance comprises petroleum hydrocarbons and/or pesticides.

In some embodiments, the active material includes one or more of the following: activated alumina, aluminosilicates, aluminum hydroxides, aluminum sulfate, aluminum-modified materials, calcium carbonates, calcium hydroxide, calcium oxide, calcium silicates, calcium sulfate, calcium-modified materials, cerium carbonate, cerium chloride, cerium hydroxide, cerium oxide, cerium oxalate, cerium sulfate, cerium-modified materials, concrete aggregate and similar materials, dolomite, magnesium carbonates, magnesium hydroxide, magnesium oxide, magnesium silicates, magnesium-modified materials, metallic iron, iron hydroxides, iron oxides, iron silicates, iron-modified materials, lanthanum carbonate, lanthanum chloride, lanthanum hydroxide, lanthanum oxide, lanthanum oxalate, lanthanum sulfate, lanthanum-modified materials, phyllosilicates, zirconium hydroxides, zirconium oxides, zirconium-modified materials, zeolites, activated carbon, layered double hydroxides, metal-modified zeolites, and heat treated nutrient binding ingredients.

In some embodiments, the active material further includes a biogenic additive. In certain embodiments, the biogenic additive can be at least one of botanical materials, invertebrate exoskeleton materials, crustacean shell materials, bivalve shell materials, modified exoskeleton materials, calciferous products, and heat-treated biogenic materials. For example, the biogenic additive can be at least one of cellulose-based barks, foliage, conifer needles, conifer cones, stalks, mulch, husks, moss, hay, roots, root structures, leaves, flowers, petioles, stems, fronds, herbs, resins, woods, sticks, calcite, aragonite, marine limestone, diatomite, chitosan, bones, antlers, horns, hooves, biochar, and bone char.

In another aspect, a method reducing an amount of a target material in a surface or subsurface water flow is provided. The method includes: providing the system as described herein (including the various embodiments described herein) on or in the ground; and allowing the active material in the system to bind to, absorb, or react to the target material to reduce the amount of the target material from the water flow passing through the system.

In a further aspect, a method of controlling water quality of a natural water body is provided, where the water body is positioned downstream to a surface or subsurface water flow, the water flow containing an undesirable target material. The method includes: providing the system (including the various embodiments) as described herein along a shore of the water body; and allowing the active material in the system to bind to, absorb, or react to the target material in the water flow passing through the system.

### BRIEF DESCRIPTION OF THE DRAWINGS

FIG. 1 depicts an example configuration of a geotextile wrapping material of a system of the present disclosure.

FIG. 2 depicts another example configuration of a geotextile wrapping material of a system of the present disclosure.

FIG. 3 depicts a system of the present disclosure as installed on a slope near a water body.

### DESCRIPTION OF EMBODIMENTS OF THE INVENTION

In one aspect, the system is configured for binding and/or removing a target substance from a fluid flow passing through the system, such as a liquid flow including, but not limited to, water. In one aspect, the present invention provides a system for removing a target substance in a surface or subsurface water flow. The system includes an enclosure formed by a geotextile wrapping material and a filling composition contained in the enclosure. The enclosure can be installed in and/or on the ground. The filling composition can include an amount of active material (or active agent) dispersed in an amount of media material, the active material capable of binding, adsorbing, absorbing, and/or otherwise reacting to the target substance, thereby reducing the amount of the target substance in the resulting water flow exiting the system as compared to the water flow entering the system. The fluid flow may be from irrigation, rain-runoff, and/or storm water effluent flow, but may also come from other sources, such as construction site runoff, industrial or agricultural effluent flow, or from any other source producing fluid from which it is desirable to remove target substances.

The target substance can include nitrogen-containing compounds, such as nitrates, nitrites, and/or ammonium. Additionally or alternatively, the target substance can also include phosphorus-containing compounds, e.g., primary phosphates such as apatite, strengite, and variscite and secondary phosphate minerals such as calcium (Ca), iron (Fe), and/or aluminum (Al) phosphates.

Further, the target substance can include other common contaminants or pollutants, such as heavy metals (including, but not limited to, mercury, lead, chromium, cadmium, arsenic, copper, nickel, zinc, etc.), petroleum hydrocarbons, pesticides, etc.

As used herein, the term “geotextile” can be any permeable textile material that can be used in and/or on soil that has the ability to separate, filter, reinforce, and/or drain. In some embodiments, the geotextile is a wrapping material that comprises a fabric having pores permeable to water. The geotextile fabric can be nonwoven, woven, or knitted. The geotextile fabric can be made of synthetic or natural polymers. For example, it can be made from high-density polyethylene or high-density polypropylene. For another example, it can be made from yarns derived from natural or biodegradable starches, burlap or other natural fibers. In some embodiments, the geotextile fabric can be made of a biodegradable polymer, such as polylactides, polyhydroxyalkanoates, etc. In some embodiments, the geotextile fabric can be photodegradable.

It is noted that the term “enclosure” formed by the geotextile wrapping material does not need to be completely closed by the geotextile wrapping material. It can be partially or semi-closed in a manner that the geotextile wrapping material provides as a barrier in a portion, e.g., a top portion, but leaves it open in a different portion, e.g., a bottom portion, where the filling composition directly contact ground or other environment and is not separated by the geotextile wrapping material from the ground or the other environment, as will be further shown and described below.

The mode the active material operates in reducing the amount of the target substance can be through physical binding (for example, adsorption and/or absorption), or chemical reaction, depending on the nature or composition of the target substance. In some embodiments, nutrients are removed from water passing through the active material by adsorption of molecules of the target substance to surfaces of particles of the active material. In some embodiments, the removal of the target substance by the active material is enhanced by the addition of one or more biogenic additives, which increase water flow therethrough, or hydraulic conductivity of, the active material while preserving or even enhancing target substance binding efficiency.

The active material can include, either alone or in combination, activated alumina, iron-enhanced activated alumina, aluminosilicates such as feldspar, bentonite clay, attapulgite clay, kaolinite, zeolite, aluminum hydroxide aluminum sulfate, aluminum-modified materials, calcium carbonate minerals, calcium hydroxide, calcium oxide, calcium silicates and calcium silicate hydrates such as wollastonite or heat-treated opoka, calcium sulfate, calcium-modified materials such as calcium alginate, cerium carbonate, cerium chloride, cerium hydroxide, cerium oxide, cerium oxalate, cerium sulfate, cerium-modified materials, concrete aggregate and similar materials (for example, crushed concrete), dolomite, magnesium carbonates, magnesium hydroxide, magnesium oxide, magnesium silicates, magnesium-modified materials, metallic iron, iron hydroxides such as goethite, iron oxides such as magnetite, iron silicates such as olivine, iron-modified materials as well as synthetic iron oxides or hydroxides (for example, those produced by thermal decomposition, precipitation, reduction, and/or calcination), lanthanum carbonate, lanthanum chloride, lanthanum hydroxide, lanthanum oxide, lanthanum oxalate, lanthanum sulfate, lanthanum-modified materials, phyllosilicates, zirconium hydroxides, zirconium oxides, zirconium-modified materials, zeolites, activated carbon, layered double hydroxides, metal-modified zeolites, and heat treated nutrient binding ingredients. However, it will be understood that suitable nutrient-binding ingredients may be used that are capable of binding, sequestering, and/or otherwise inactivating nutrients and/or compounds from water or sediment other than or in addition to nitrogen and/or phosphorus.

For removal of phosphorus (including phosphate or other phosphorus containing compounds), active material comprising lanthanum (La)-based adsorbents can be particularly effective. La-based absorbents include, but are not limited to, lanthanum oxide/hydroxide, lanthanum mixed metal oxide/hydroxide, lanthanum carbonate, lanthanum chloride, lanthanum oxalate, lanthanum sulfate, lanthanum nitrate, lanthanum-modified materials, La-based metal-organic framework (La-MOF), and/or La-MOF derivatives. The La-based adsorbents can be loaded on carriers, such as activated carbon, clay minerals, porous silica, polymers, etc.

For absorption of heavy metals such as Pb and Arsenic, the active material can be those porous ceramic composites with zero-valent ions loaded in the pores as disclosed in U.S. Pat. Nos. 9,988,285, 11,186,498 and US Patent App. Pub. No. 20190106337, the entirety of which are incorporated herein by reference.

The active material of the present invention can include any one or combination of the substances herein.

In some embodiments, the active material is in the form of a particulate matter or granules, and the average pore size of the porous fabric material (e.g., apparent opening size under certain ASTM standard) are smaller than the average size of the particulates or granules of the active material, such that the active material can be retained in the enclosure for a long term. Further, in some embodiments, the active material is a porous material having a surface area of at least 50 m²/g.

The active material can be capable of being regenerated after reacting or binding to the target substance. After the target substance, e.g., nutrients such as nitrogen compounds or phosphorus compounds, are bound to the active material, they can remain plant available and the roots of plants growing in the filling composition can strip the nutrients from the active material.

In some embodiments, the filling composition further includes at least one biogenic additive as a functional additive that binds, sequesters, and/or otherwise inactivates the target material (including, but not limited to, nutrients such as nitrogen and/or phosphorus) from the water and/or that otherwise enhance or facilitate the binding efficacy of the active material. For example, the filling composition may include a combination of active material and biogenic additive, such as is disclosed in U.S. Pat. No. 12,134,083, the entirety of which is incorporated herein by reference. In embodiments that further include the at least one biogenic additive, the active material and the biogenic additive(s) may be collectively referred to herein as the “active material” for simplicity. In some embodiments, the filling composition includes a first amount of at least one active material and a second amount of at least one biogenic additive, the first amount being greater than or equal to the second amount. The at least one active material and the at least one biogenic additive may have a synergistic effect on the amount of the target substance removed from a volume of water by the active material. For example, in one embodiment, such a filing composition removes a greater amount of the target substance from a volume of water, or has a greater removal capacity, than the combined removal capacity of all ingredients considered separately.

In some embodiments, the at least one biogenic additive does not bind the target material itself, but acts synergistically with the active material to increase the expected binding effect of the filing composition. In other embodiments, the at least one biogenic additive binds at least some nutrients from the water (for example, from water flowing through the enclosure and the filling composition, water into which the enclosure and the filling composition is placed, or in other arrangements). Additionally, in some embodiments, the biogenic additive(s) have a particle size of between approximately 1 mm and 25 mm (±5 mm) and/or porosity of at least 0.25. In some embodiments, the biogenic additive(s) are not porous, but are used to increase the overall porosity (and, therefore, hydraulic conductivity) of the filling composition. As used herein, the term “biogenic” refers to materials that are produced by, from, or of life forms. For example, suitable biogenic additives, either alone or in combination, include botanical materials (for example, dried plant materials) such as cellulose-based barks, foliage, conifer needles, conifer cones, stalks, mulch, husks, moss, hay, roots or root structures, leaves, fronds, flowers, petioles, stems, herbs, resins, woods, sticks, and the like; crustacean and/or bivalve shells such as calcite, aragonite, marine limestone, and oyster shells; invertebrate exoskeletons such as diatomite; modified exoskeletons such as chitosan; calciferous products such as bone, antlers, horns, hooves; and/or heat-treated biogenic materials such as biochar, bone char, and others. However, it will be understood that suitable biogenic additives may include other materials that are capable of binding, sequestering, and/or otherwise inactivating nutrients and/or compounds from water other than or in addition to nitrogen and/or phosphorus and/or of acting synergistically to enhance the binding capacity of active material in the filling composition. It will also be understood that non-biogenic materials may be used, instead of or in addition to biogenic materials, that can mimic the design, size, and/or texture of biogenic materials (for example, fabrics, textiles, synthetic fibers, plastics, polymers, metals, modified metals, ceramics, composites, nanoparticle formulations, materials with amorphous crystal structures, and/or the like). Such non-biogenic materials may provide similar abilities to open pore size and synergistically improve the binding characteristics of nutrients such as phosphorus and/or nitrogen. In addition, such non-biogenic materials may be blended, adhered to, burned together with, and/or mechanically pulverized together with biogenic materials to produce similar results.

The media material can include sand, stones, earth, organic material, recycled materials, construction fill, compactable soils, etc.

The amount of the active material versus the amount of the media material and/or the biogenic additive(s) in the filling composition can depend on the specific applications. For example, the active material can constitute from about 1% to about 50% by weight, from about 1% to about 20% by weight, from 1% to about 10% by weight, or from about 1% to about 5% by weight, of the filling composition. As used herein, the term “about” or “approximately” with respect to a referenced value means within +5% of the referenced value.

The active material (and, optionally, biogenic additive(s)) can be either pre-mixed with the media material, hydraulically introduced to the media material during deployment of the system, or otherwise deposited within the containment component (enclosure) of the system. The active agent can be added to the media as a direct additive as a measured component of the media, or bound to a granular substrate as delivery vehicle and of a particulate size in excess of the average opening size of the porosity of the geotextile wrapping.

In another aspect, the present invention provides a method reducing an amount of a target material contained in an environment, by installing or positioning a system described herein at a predetermined location (such as a bank or shore of a water body, a slope or hillside, or other places as desired where a surface or subsurface water flow carrying the target substance is likely), and allowing the active material in the system to bind to, adsorb, absorb, or react to the target material in the water passing through the system. When the system is installed along a shore of a water body, such as a lake, a pond, a creek, etc., the method can be used to control or improve water quality of the water body. In some embodiments, the system is installed such that it is buried or at least partially buried beneath the soil surface. In some embodiments, the system is installed such that at least a portion is within, submerged within, and/or otherwise in contact with a body of water (moving or still).

The system 100 generally includes an enclosure and a filing composition. In some embodiments, the enclosure includes a geotextile sheet that takes an open sheet configuration. In certain embodiments, the geotextile comprises at least a first and second edge, and channels formed at each of the first edge and the second edge. Each of the channels comprising a draw cord threaded therethrough, with each of the channels comprising a plurality of openings, and the draw cord extends through the plurality of openings for securement.

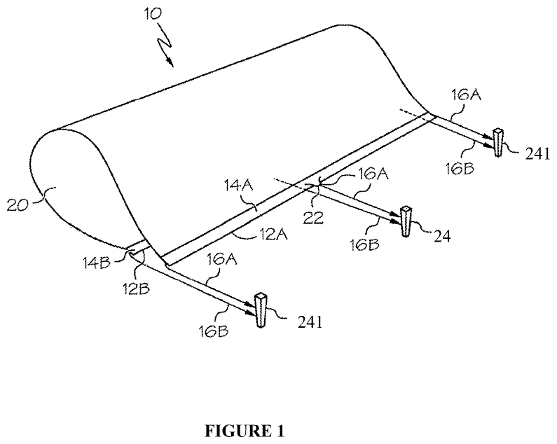

As illustrated in FIG. 1, the geotextile sheet 10 has the two opposing edges that are not closed. Sheet 10 comprises a first edge 12A and second opposing edge 12B. First edge 12A comprises a first channel 14A and second edge 12B comprises a second channel 14B. Each channel 14A, 14B further comprises at least one draw cord (or anchor rope) 16A and 16B extending therethrough. Anchor rope 16A, 16B can be formed from any suitable rope material. In some embodiments, anchor rope 16A, 16B is formed from polypropylene.

The geotextile sheet 10 can further include an opening 22 in channel 14B (as well in channel 14A) and extending therethrough is shown a loop of anchor rope 16B. This allows the sheet to be secured by anchor rope 16A and/or 16B at a plurality of locations, suitably, each opening 22 is uniformly spaced along the length of geotextile sheet 10.

The system can further include securing stakes connected to the anchor ropes for securing the anchor ropes to the ground. For example, and again referring to FIG. 1, the end portions of the anchor ropes 16A and 16B can be connected to outer stakes 241 and intermediate exposed portions of anchor ropes 16A and 16B can be connected to an intervening stake 24. Alternatively, the anchor ropes 16A and 16B can stay through their respective channels and at each opening 22 a separate securing cord can be coupled to the exposed anchor ropes 16A/16B to the intervening stake 24. It is understood that anchor ropes at corresponding positions do not have to be secured on the same stakes, but can be secured on different stakes. If the area where the system is installed has a slope, e.g., on a river bank, the first edge can be usually installed on a lower position on the slope (closer to the water) whereas the second edge is positioned up the slope (and further away from the water).

The filling composition as described herein may be placed in the space 20 formed by the geotextile sheet 10, thereby secured by the enclosure. For example, a procedure for installing the system can be as follows: (1) securing at least one edge of the geotextile sheet to the ground, e.g., using the stakes driven to the ground, the stakes tethered to the anchor ropes, thereby forming a space to accommodate the filling composition; and (2) disposing the filling composition into the accommodating space formed by the geotextile sheet. The other edge of the geotextile sheet can then be secured to the ground. More specifically, referring to a system as shown in FIG. 1, placing a plurality of stakes in a substantially linear pattern (or other patterns as needed) into the ground, the plurality of the stakes comprising two outer stakes and at least one intervening stake; securing a first edge of the sheet to the plurality of stakes by securing two ends of the first anchoring rope to the two outer stakes, and coupling the at least one exposed segment of the first anchoring rope to the at least one intervening stake; arranging the sheet so that at least a portion of the sheet proximate the first edge is lying flat on the ground and forms an holding region extending from the first edge; disposing the filling composition on top of the holding region such that the filling composition is disposed on top of the first edge; bringing the second edge of the sheet over the first edge, thereby trapping the disposed filling composition by the geotextile sheet (for example, within the space 20 formed by the geotextile sheet 10); and securing the second edge of the sheet to the ground by the plurality of stakes by securing two ends of the second anchoring rope to the two outer stakes (or other stakes), and coupling the at least one exposed segment of the second anchoring rope to the at least one intervening stake (or another stake). At the completion of the installation, along at least a portion of the first edge is free from attachment to the second edge, and the second edge is disposed between the first edge and the plurality of stakes.

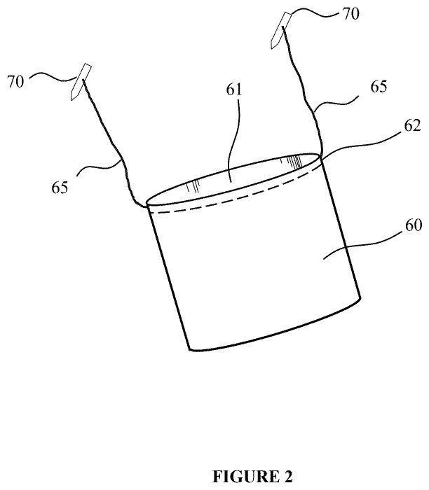

In other embodiments, the geotextile wrapping material can be in the form of a closable bag with an edge secured by anchor ropes tethered on stakes. For example, and as shown in FIG. 2, the geotextile sheet 60 may be in the form of a closable bag having an opening 61, a channel 62 extending at least partially around the opening, and one or more anchor ropes 65 which can be threaded within the channel 62, such that the bag is closable as a drawstring bag. The anchor ropes 65 can further extend out of the channel 62 and tethered to anchoring stakes 70 on their distal ends. The anchoring stakes 70 are configured and/or constructed to be driven to the ground to secure the geotextile sheet.

In some embodiments, the geotextile wrapping material is flexible and is malleable enough to at least substantially conform to the topography of the installation location, including when the wrapping material is filled with the filling composition. In this manner, the system may be used in a variety of installation locations to, for example, preserve slope contours, create a desired bank shape, fit within and/or cover uneven ground to create a smooth surface, expand or compress to provide sufficient nutrient removal surface area within a treatment area, accommodate planted or volunteer vegetation, or otherwise provide versatility, waste removal efficiency, and aesthetic appeal in the landscape.

In some embodiments, the system can further include or be used in association with vegetation, such as grass or other plants, which can grow through the pores of the geotextile sheet installed in the ground. For example, in one embodiment, the system is installed beneath the soil surface and vegetation is planted and/or allowed to grow within the soil, above and/or around the buried system. In this manner, the roots of the vegetation are positioned to grow through the powers of the geotextile sheet and to come into contact with the filling composition. If nutrients such as nitrogen compounds and/or phosphorus compounds are bound to the active material, the plant roots may desorb, strip, remove, and/or otherwise access and use the nutrients from the active material. The active material is then free to bind additional target material.

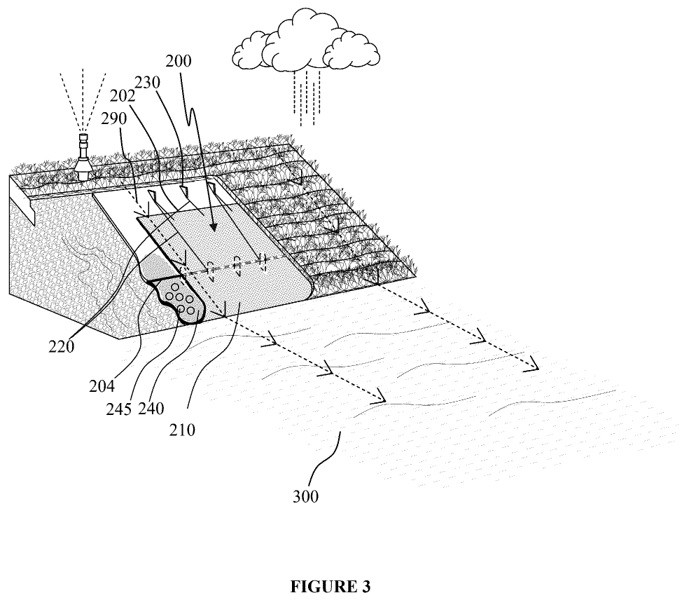

FIG. 3 illustrates a scenario where a system 200 described herein is installed on a bank slope near a water body 300 (a lake or a pond, for example). The open geotextile sheet 210 has a first edge 202 and a second edge 204 and forms a wrapped or taco-like configuration (the second edge 204 positioned underneath a top portion of the geotextile sheet), enclosing a filling composition 240 containing active material 245. The edges are secured by anchoring ropes 220 and anchors (stakes) 230 as described above. The wrapped configuration of the geotextile sheet 210 may be arranged such that geotextile sheet 210 encloses the filling composition at the end closer to the water (downslope) to prevent loss, and remains open at the end farther away from the water (upslope). Surface or subsurface water 290 from irrigation, rain-runoff or eluent flow will infiltrate the system, interact with the active agent and exfiltrate the system, such as through the pores and/or openings in the geotextile sheet 210 proximal to the water body 300, resulting in improved water quality in the water body 300, e.g., reduced amount of nutrients.

It will be appreciated by those skilled in the art that the present invention is not limited to the embodiments described herein. It is understood that various changes, substitutions and alterations can be made by those of ordinary skill in the art without departing from the spirit and scope of the invention.

1. A system for removing a target substance in a surface or subsurface water flow, comprising:
an enclosure formed by a geotextile wrapping material; and
a filling composition contained in the enclosure, the filling composition including an amount of active material dispersed in an amount of media material, the active material capable of binding, absorbing or otherwise reacting to the target substance, thereby reducing the amount of the target substance from the resulting surface or subsurface water flow exiting the system.

2. The system of claim 1, wherein the geotextile wrapping material comprises a knitted or woven fabric having pores permeable to water.

3. The system of claim 2, wherein the fabric material is made from high-density polyethylene or polypropylene.

4. The system of claim 1, wherein the enclosure is installed on or in the ground.

5. The system of claim 4, wherein the geotextile wrapping material includes a first edge and a second edge opposing the first edge, the first edge and the second edge being spaced apart by the filling composition.

6. The system of claim 5, wherein the geotextile wrapping material further comprises:
a first channel formed at the first edge, and a second channel formed at the second edge; and
a first draw cord threaded through the first channel, and a second draw cord threaded through the second channel.

7. The system of claim 4, wherein at least one of the first edge and the second edge is secured to the ground by at least one stake.

8. The system of claim 7, wherein the at least one stake includes a plurality of stakes each coupled to either or both of the first draw cord and the second draw cord.

9. The system of claim 4, wherein the geotextile wrapping material is in the form of a closable bag.

10. The system of claim 1, wherein the active material is in the form of a particulate matter, and the average pore size of the geotextile wrapping is smaller than the average size of the active material particulates.

11. The system of claim 1, wherein the target material comprises an organic or inorganic compound containing phosphorous or nitrogen.

12. The system of claim 1, wherein the target substance comprises heavy metals.

13. The system of claim 1, wherein the target substance comprises petroleum hydrocarbons and/or pesticides.

14. The system of claim 1, wherein the active material includes one or more of the following: activated alumina, aluminosilicates, aluminum hydroxides, aluminum sulfate, aluminum-modified materials, calcium carbonates, calcium hydroxide, calcium oxide, calcium silicates, calcium sulfate, calcium-modified materials, cerium carbonate, cerium chloride, cerium hydroxide, cerium oxide, cerium oxalate, cerium sulfate, cerium-modified materials, concrete aggregate and similar materials, dolomite, magnesium carbonates, magnesium hydroxide, magnesium oxide, magnesium silicates, magnesium-modified materials, metallic iron, iron hydroxides, iron oxides, iron silicates, iron-modified materials, lanthanum carbonate, lanthanum chloride, lanthanum hydroxide, lanthanum oxide, lanthanum oxalate, lanthanum sulfate, lanthanum-modified materials, phyllosilicates, zirconium hydroxides, zirconium oxides, zirconium-modified materials, zeolites, activated carbon, layered double hydroxides, metal-modified zeolites, and heat treated nutrient binding ingredients.

15. The system of claim 1, wherein the active material further includes a biogenic additive.

16. The system of claim 15, wherein the biogenic additive is at least one of botanical materials, invertebrate exoskeleton materials, crustacean shell materials, bivalve shell materials, modified exoskeleton materials, calciferous products, and heat-treated biogenic materials.

17. The system of claim 15, wherein the biogenic additive is at least one of cellulose-based barks, foliage, conifer needles, conifer cones, stalks, mulch, husks, moss, hay, roots, root structures, leaves, flowers, petioles, stems, fronds, herbs, resins, woods, sticks, calcite, aragonite, marine limestone, diatomite, chitosan, bones, antlers, horns, hooves, biochar, and bone char.

18. A method of reducing an amount of a target material in a surface or subsurface water flow, comprising:
providing the system of claim 1 on or in the ground; and
allowing the active material in the system to bind to, absorb, or react to the target material to reduce the amount of the target material from the water flow passing through the system.

19. A method of controlling water quality of a natural water body, the water body being positioned downstream to a surface or subsurface water flow containing an undesirable target material, comprising:
providing the system of claim 1 along a shore of the water body;
allowing the active material in the system to bind to, absorb, or react to the target material in the water flow passing through the system.
